(19) United States
(12) Patent Application Publication
(10) Pub. No.: US 2010/0023375 A1
(43) Pub. Date: Jan. 28, 2010

(54) Fair Allocation of Overlapping Inventory

(75) Inventors: John Tomlin, Sunnyvale, CA (US); Deepak K. Agarwal, Sunnyvale, CA (US)

Correspondence Address: Weaver Austin Villeneuve & Sampson - Yahoo!, P.O. BOX 70250, OAKLAND, CA, 94612-0250, US

(73) Assignee: YAHOO! INC.

(21) Appl. No.: 12/180,424

(22) Filed: Jul. 25, 2008

(51) Int. Cl. G06Q 10/00; G06Q 30/00

(52) U.S. Cl. 705/10

(57) ABSTRACT

Methods and apparatus for allocating inventory are disclosed. The system may maintain a plurality of inventory pools of impressions that are projected to be available during a time period, each of the plurality of inventory pools having a corresponding set of attributes. The system may receive a plurality of requests from advertisers, each of the plurality of requests requesting a number of impressions during the time period that satisfy a corresponding demand profile, the demand profile having a corresponding set of attributes. The system may allocate impressions in the plurality of inventory pools to the plurality of requests by balancing an interest of a seller of the impressions to maximize value of remaining inventory in the plurality of inventory pools against an interest of the advertisers in allocating a representative sample of impressions in each of the plurality of inventory pools that satisfy the demand profile for each of the plurality of requests.

### BACKGROUND OF THE INVENTION

The present invention relates generally to inventory allocation. More particularly, the present disclosure relates to techniques for allocating overlapping inventory.

The Internet has become a mass media on par with radio and television. Similar to radio and television content, Internet content is largely supported by advertising dollars. Two of the most common types of advertisements on the Internet are banner advertisements and text link advertisements. Banner advertisements are generally images or animations that are displayed within an Internet web page. Text link advertisements are generally short segments of text that are linked to the advertiser's web site via a hypertext link.

To maximize the impact of Internet advertising (and maximize the advertising fees that may be charged), Internet advertising services such as ad networks display advertisements that are most likely to capture the interest of the web user. An interested web user will read the advertisement and may click on the advertisement to visit a web site associated with the advertisement.

To select the best advertisement for a particular web user, an advertising service may use whatever information is known about the web user. However, the amount of information known about the web user will vary heavily depending upon the circumstances. For example, some web users may have registered with the web site and provided information about themselves while other web users may not have registered with the web site. Some registered web users may have completely filled out their registration forms whereas other registered web users may have only provided the minimal amount of information to complete the registration. Thus, the quality of the various different advertising opportunities will vary.

Since the quality of the advertising opportunities will vary, an Internet advertising service should be careful to use the advertising opportunities in the most optimal manner possible. For example, an advertising opportunity for an anonymous web user is not as valuable as an advertising opportunity for a web user who has registered and provided detailed demographic information. Thus, it would be desirable to be able to optimally allocate the various different advertising opportunities to different advertisers and advertising campaigns.

At the same time, each of the advertisers has an interest in receiving the optimal value of the advertising opportunities for their own advertising campaigns. Unfortunately, the interest of the advertisers to receive the optimal value for the money it pays for its advertising opportunities may conflict with the interest of the Internet advertising service.

### SUMMARY OF THE INVENTION

Methods and apparatus for allocating inventory are disclosed. In the following description, the inventory allocation schemes refer to the allocation of inventory that includes advertising opportunities. Each of these advertising opportunities may be referred to as an “impression.”

In accordance with one embodiment, the system may maintain a plurality of inventory pools of impressions that are projected to be available during a time period, each of the plurality of inventory pools having a corresponding set of attributes. The system may receive a plurality of requests from advertisers, each of the plurality of requests requesting a number of impressions during the time period that satisfy a corresponding demand profile, the demand profile having a corresponding set of attributes. The system may allocate impressions in the plurality of inventory pools to the plurality of requests by balancing an interest of a seller of the impressions to maximize value of remaining inventory in the plurality of inventory pools against an interest of the advertisers in allocating a representative sample of impressions in each of the plurality of inventory pools that satisfy the demand profile for each of the plurality of requests.

In accordance with another embodiment, a set of attributes may be associated with a set of impressions, where the set of impressions are in an inventory pool or the set of impressions is requested. The set of attributes may define any number and types of characteristics of the impressions or individuals associated with those impressions. For instance, the attributes may include age, location, and/or sex. As another example, the attributes may include behavioral attributes, such as prior purchase history or prior web activity.

In another embodiment, the invention pertains to a device comprising a processor, memory, and a display. The processor and memory are configured to perform one or more of the above described method operations. In another embodiment, the invention pertains to a computer readable storage medium having computer program instructions stored thereon that are arranged to perform one or more of the above described method operations.

These and other features and advantages of the present invention will be presented in more detail in the following specification of the invention and the accompanying figures which illustrate by way of example the principles of the invention.

### BRIEF DESCRIPTION OF THE DRAWINGS

FIG. 1 is a diagram illustrating an example system in which an advertising service manages the distribution of advertisements and collects data regarding advertising opportunities.

FIG. 2 is a Venn diagram illustrating an example of various overlapping sets of advertising opportunities.

FIG. 3 is a process flow diagram illustrating an example method of allocating advertising opportunities in response to requests from advertisers.

FIG. 4 is a simplified diagram of a network environment in which specific embodiments of the present invention may be implemented.

### DETAILED DESCRIPTION OF THE SPECIFIC EMBODIMENTS

Reference will now be made in detail to specific embodiments of the invention. Examples of these embodiments are illustrated in the accompanying drawings. While the invention will be described in conjunction with these specific embodiments, it will be understood that it is not intended to limit the invention to these embodiments. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well known process operations have not been described in detail in order not to unnecessarily obscure the present invention.

In the following description, each advertising opportunity may be referred to as an impression. The inventory of impressions may be grouped and organized into a plurality of inventory pools. While each of the plurality of inventory pools is a separate pool, two or more inventory pools may overlap with one another. For instance, an inventory pool of males may overlap an inventory pool of individuals living in the U.S., as well as an inventory pool of individuals between the ages of 20-30. Thus, the inventory may be referred to as “overlapping.”

In order to more accurately group the impressions, the inventory may be grouped into disjoint pools. In other words, the disjoint pools do not overlap with one another. Each of these disjoint pools has an associated set of attributes. For example, a disjoint pool may include males who are between the ages of 20-30 who do not live in the U.S.

An Internet advertising service may receive numerous requests from advertisers. Each of these requests may identify a specific number of impressions that are desired that satisfy a particular set of attributes. For instance, an advertiser may request that the Internet advertising service provide a million impressions that are male. In this example, the Internet advertising service has a number of options available to it, since there are a number of disjoint pools that include impressions that are male. For example, the males may be living in the U.S. or outside the U.S., as well as within various age ranges. As a result, there are a number of different ways that the Internet advertising service may satisfy this request from the different disjoint inventory pools. This process is further complicated by the fact that the Internet advertising service may receive requests from a plurality of advertisers, as well as multiple requests from the same advertiser. As a result, allocating impressions can be a complex process.

In the following description, methods for allocating overlapping inventory are described. However, in order to describe these methods, it is useful to first describe the general process by which advertisements are distributed and impressions are collected.

The Internet has become a mass media that includes web sites, many of which are supported by advertising. Specifically, web site publishers provide interesting content that attracts web site viewers and the web site publishers intersperse paid advertisements into the web pages. The fees from the advertisers compensate the web site publisher for the web site hosting and the costs of creating the interesting content that attracts the web users. Some Internet web site advertisements are banner advertisements including an advertiser-supplied graphical image or animation. Other Internet web site advertisements merely consist of simple short strings of text and hypertext links.

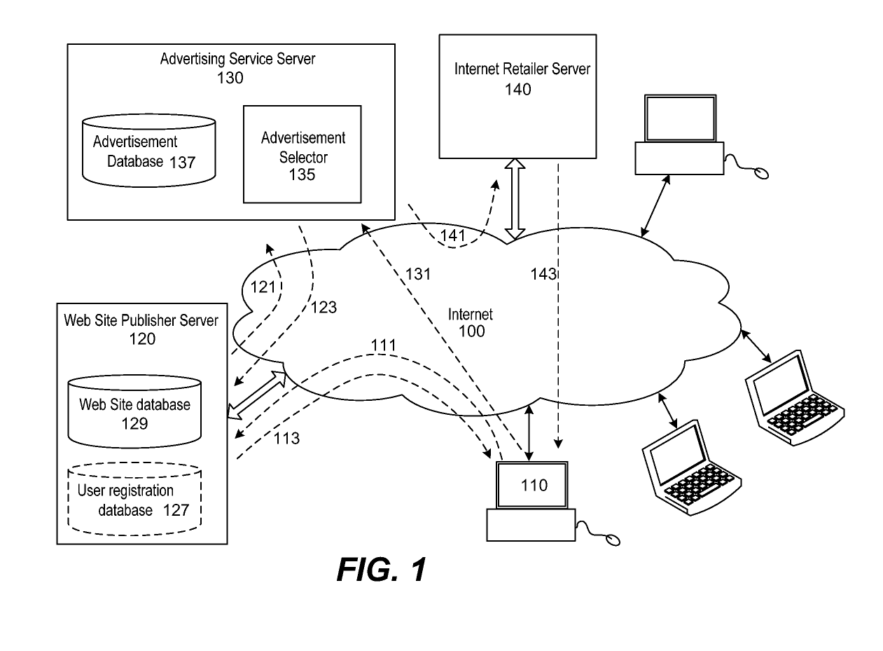

The advertisements within an advertisement-supported web site are often provided to a commercial web site publisher by an Internet advertising service. FIG. 1 is a block diagram illustrating a system in which an Internet advertising service and a web site publisher may operate. Referring to FIG. 1, an Internet based retailer server 140 that sells products (or services) to Internet users may wish to seek additional customers. Thus, the Internet based retailer may sign up with an Internet advertisement service 130 in order to promote the web site of the Internet based retailer. The Internet advertisement service 130 may handle the display of Internet advertisements by attempting to place the advertisements within web sites that have web viewers who may be interested in the products (or services) sold by the Internet based retailer.

A web site served by the web site publisher server 120 may contain web pages viewed by web users interested in the Internet retailer's products or services. Thus, when an Internet user at computer 110 requests a web page published by web site publisher server 120 (along request communication 111), web site publisher server 120 may subsequently request an advertisement from Internet advertisement service (e.g., server) 130 (along request 121) and receive an advertisement for the Internet retailer (along response 123). The web site publisher server 120 may then deliver the requested web page along with the selected advertisement along response 113 such that the user at computer 110 is exposed to an Internet advertisement that advertises the offerings of the Internet retailer server 140.

If the Internet user at computer 110 is sufficiently interested in what is presented within the advertisement, the Internet user may click on the advertisement such that the user will be re-directed to the Internet retailer server 140. The user may be re-directed to the Internet retailer server 140 through an advertising service server 130 that will record the user's selection of the advertisement in order to bill the advertiser for the selection of the advertisement. Once the user has been re-directed to the Internet retailer server 140, the user at computer 110 may purchase goods or services directly from the Internet retailer server 140.

The web site publisher server 120 may have a user registration database 127 wherein web site publisher server 120 stores information about users who have registered with the web site in order to obtain premium content. When a registered web user visits web site publisher server 120, then web site publisher server 120 may provide some demographic information about that registered user to advertising service server 130 along with advertisement request 121. An advertisement selector 135 at advertising service server 130 may use that demographic information about the web user in order to select an advertisement specifically tailored for the demographic group of that web user.

Furthermore, web site publisher server 120 may provide the IP address from the web user's computer 110. In some cases, advertisement selector 135 may use an IP address to geographical location lookup table to determine a general geographic location of the web user's computer 110. Thus, advertisement selector 135 may use that general geographic location when considering what advertisement to select for display to that web user.

Over time advertising service server 130 can store the IP address and/or other demographic information associated with each advertising opportunity. In addition, the browsing history of registered and non-registered users may also be maintained in the form of inferred behavioral attributes. From this information, the advertising service server 130 can statistically determine what proportion of advertising opportunities will have detailed demographic information, what proportion of advertising opportunities will be from a certain geographic location, and other useful advertising forecast information (e.g., sex of the user, age of the user, etc.). That advertising forecast information can be used to optimize the usage of the advertising opportunities. More specifically, the advertising forecast information can be used to allocate these advertising opportunities among requests from advertisers in order to satisfy contracts with the advertisers, as will be described in further detail below.

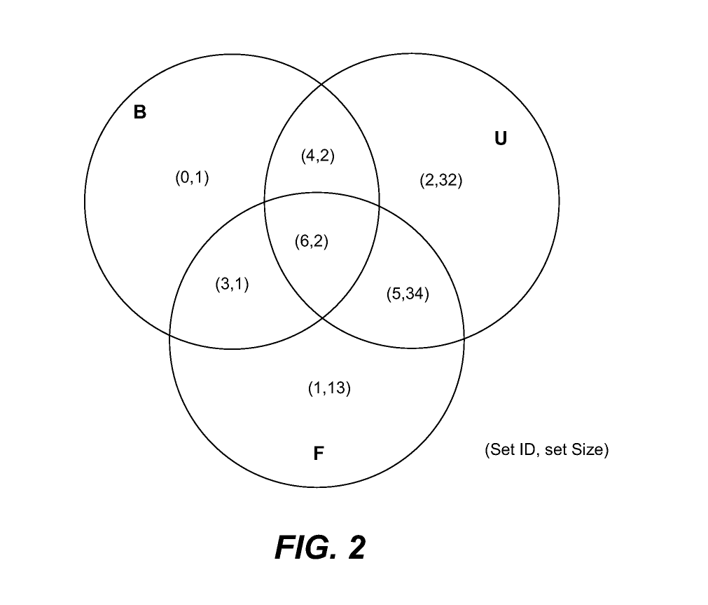

FIG. 2 is a Venn diagram illustrating an example of one possible forecast for advertising opportunities (also known as advertising inventory). Each different distinct set of advertising opportunities (i.e., impressions) may correspond to an inventory pool. Each different set of advertising inventory is labeled with two numbers in parentheses “(#,#)” where the first number indicates a set identifier (or inventory pool identifier) and the second number indicates a number of impressions in millions projected to be available in the time period.

As shown in FIG. 2, the advertising opportunities have been divided into three groups: advertising opportunities that may be Behaviorally-Targeted (labeled “B” in the diagram), advertising opportunities for Females (labeled “F” in the diagram), and advertising opportunities for web viewers in the USA (labeled “U” in the diagram). The intersection of the groups represents advertising opportunities that satisfy more than one condition (or attribute). For example, set 4 (labeled “(4,2)” in the diagram) represents advertising opportunities for people in the USA (set “U”) that may be behaviorally targeted (set “B”).

Each of the identified sets may be referred to as disjoint inventory pools, where each of the disjoint inventory pools has an associated set of attributes. Each of these disjoint inventory pools may be used to satisfy requests for advertising inventory, where each of the requests has an associated demand profile. More specifically, the demand profile may have an associated set of attributes that define the requirements of the advertiser for the inventory that will be used to satisfy the requests. For instance, various attributes may identify the sex, age, geographic location, and/or behavioral attributes of the corresponding advertising opportunity.

The sets corresponding to the disjoint inventory pools are used to satisfy requests for advertising inventory having an associated set of attributes. The sets may be labeled as sets Sⱼ={f₁^{j}, . . . , f_{M}^{j}}, where fₓ^{j} is set to one if the set j has an associated attribute corresponding to that particular field, and zero otherwise. For example, the sets illustrated in FIG. 2 are:

TABLE 1
B, F, U

S₀ = {1, 0, 0}B
S₁ = {0, 1, 0}F
S₂ = {0, 0, 1}U
S₃ = {1, 1, 0}BF
S₄ = {1, 0, 1}BU
S₅ = {0, 1, 1}FU
S₆ = {1, 1, 1}BFU

Referring to FIG. 2, the second number in each parenthesis pair is the available inventory in millions for a specific set, excluding proper subsets. Thus, although there is a total of 70 million impressions in the U pool (set 2), the number shown is 32 because it excludes the inventory in the proper subsets BU, FU, and BFU. Similarly, the inventory in set FU is 36 million but shown as 34 million by the pair (5,34), since it excludes the 2 million units in proper subset BFU. (If not disjoint, the subsets of a set may be obtained by putting in 1s where the set has 0s.)

The various subsets of FIG. 2 may define pools of targeted advertising inventory. Advertising inventory from a pool may only be assigned to an advertising opportunity request for a demand profile if that pool belongs to a subset (inclusive) of the requested pool. Thus, to satisfy a particular advertising inventory request, the advertising inventory should match the demand profile of the request or be a proper subset of the demand profile. For example, an advertising request for an “F” advertising opportunity may be satisfied from set 1 (“F”), set 3 (“BF”), set 5 (“FU”), or set 6 (“BFU”).

The following list of elements can be used to fully define the overlapping inventory optimization problem.

| | |
|---|---|
| Indices | |
| j = 1, . . . , J | The indices of the disjoint inventory pools (e.g., |
| | subsets) |
| k = 1, . . . , K | The indices of the requested inventory sets |
| | (demands) |
| Data | |
| Vⱼ | Expected future value of inventory in disjoint pool |
| | Sⱼ |
| sⱼ | Size of the disjoint inventory supply pool Sⱼ |
| dₖ | Aggregate requested volume for demand profile Sₖ |
| Sⱼ = {f₁^{j}, . . . , f_{M}^{j}} | Set of attributes of pool j |
| Variables | |
| xⱼₖ | Volume of supply pool j inventory assigned to |
| | request(s) for inventory type k |
| yⱼ | Unused inventory in pool j |

Historical sales information may be used to assign a value to each of the pools of impressions. For instance, a pool that has associated behavioral attributes may be assigned a higher value than a pool that does not have associated behavioral attributes. As another example, a pool that has targeting attributes that indicate an age and sex of the impressions will be more valuable than a pool that merely has a single targeting attribute indicating a sex of the impressions. Values that are assigned may be, for example, integers between 0 and 10.

Historically, inventory has been allocated proportionally. However, this strategy has resulted in substantial revenue loss when advertising campaigns specifically requested inventory that was no longer available. As a result, sellers of inventory have attempted to cherry pick the inventory in order to maximize the value of their remaining inventory. However, this approach has been detrimental to the quality of the inventory that has been guaranteed to advertisers.

As set forth above, the interests of the seller to maximize the value of the remaining inventory will generally motivate the seller to try to retain some of the more valuable inventory. At the same time the interests of the advertisers is to maximize the value of the advertising opportunities that they receive for their advertising dollars. As a result, the interests of the seller conflict with the interests of the advertisers. The disclosed embodiments enable inventory to be allocated fairly to accommodate the interests of the seller of the inventory and the advertisers.

Seller's Interest: Maximizing Remaining Inventory

If we were to maximize the value of the remaining inventory, one way to represent this mathematically would be:

Maximize Σⱼ Vⱼyⱼ (1)

Stated another way, Sₖ₊₁ may designate the set of demands for the surplus supply:

$$Supply {\sum }_{k \vert Sj ⊆ Sk}^{ } {x}_{jk} = {s}_{j} ∀ j = 1 , … , J$$

$$Demand {\sum }_{j \vert Sj ⊆ Sk}^{ } {x}_{jk} = {d}_{k} ∀ k = 1 , … , K + 1$$

However, this model optimizes inventory allocation for the seller only.

Advertisers' Interest

In order to ensure that the advertisers receive a fair value for their advertising dollars, the inventory may be allocated in a way that each advertiser is allocated a “representative sample” of the inventory. This is also in the long-term interest of the seller since it increases the market value of the seller's inventory.

If every inventory pool could supply every demand, “fairness” could be achieved by proportional allocation. That is, by allocating

Xⱼₖ=(sⱼ×dₖ)/X, where X=Σ_{j,k} xⱼₖ, the total inventory.

However, in the more general case, every pool will not be able to supply every demand. As a result, we can obtain a solution as close to the representative as possible by maximizing an entropy function:

$$E = - {\sum }_{j , k}^{ } {x}_{jk} ln ( {x}_{jk} )$$

subject to (2) and (3).

Fairness

In order to fairly allocate inventory, an objective function that is a weighted composite of (1) and (4) may be maximized:

$$Maximize {\sum }_{j}^{ } {V}_{j} {y}_{j} - γ {\sum }_{j , k}^{ } {x}_{jk} ln ( {x}_{jk} ) ,$$

xⱼₖ ln(xⱼₖ), where γ is a weighting value

subject to (2) and (3). We may think of this as adding a constraint which specifies a fixed value for the entropy, i.e.

$${\sum }_{j , k}^{ } {x}_{jk} ln ( {x}_{jk} ) = Const$$

for which γ is the Lagrange multiplier, or alternatively of specifying a constraint on the value of the unused inventory, i.e.

$${\sum }_{j}^{ } {V}_{j} {y}_{j} = Const$$

where the Lagrange multiplier is γ⁻¹.

We may choose γ as the weighting of the two components. (Alternatively, we may choose a value for the constant specified in (6) or (7).) This weighting value γ may then be applied to find the solution to this problem, as follows.

We define:

cⱼₖ={0 j=1, . . . , J; k=1, . . . , K

{Vⱼ j=1, . . . , J; k=K, . . . , 1

then assigning Lagrange multipliers λⱼ and μₖ to the equations (1) and (2),

ln(xⱼₖ)=(λⱼ+μₖ+cⱼₖ)/γ (8)

Substituting this expression back into (1) and (2), the solutions of this problem can be put in the form:

Xⱼₖ=AⱼBₖsⱼdₖ exp(cⱼₖ/γ) ∀ S̅_{j⊂}Sₖ

where Aⱼ and Bₖ are given by:

Aⱼ=[Σ_{k| S̅j⊂Sk} Bₖdₖ exp(cⱼₖ/γ)]⁻¹ (j=1, . . . , J)

Bₖ=[Σ_{j| S̅j⊂Sk} Aⱼsⱼ exp(cⱼₖ/γ)]⁻¹ (k=1, . . . , K+1)

In this manner, the interest of the seller may be balanced against the interest of the advertisers using a weighting value. The solution may be obtained by an iterative scaling algorithm, or alternatively, by solving the nonlinear program with a general Natural Language Processing (NLP) algorithm, such as MINOS™, available from Stanford Business Software, Inc. located in Palo Alto, Calif. In this manner, the impressions from the pools of inventory may be allocated (e.g., guaranteed) to the various requests received from advertisers.

In accordance with one embodiment, an advertiser may request a fixed amount of a specific type of inventory. It may then be determined whether this request can be fulfilled, and if so, which inventory from which pools should be allocated to meet this new request, as well as all other requests. This may be accomplished by using the variable dₖ to identify the requested fixed amount of the specific type of inventory Sₖ. The solution may then be obtained for Xⱼₖ, as set forth above.

Modified Solution

To ensure representative allocation relative to some pre-defined allocation Xⱼₖ₀, we can modify the entropy term (4) in the composite objective (5) to

$${\sum }_{j , k}^{ } {x}_{jk} ln ( {x}_{jk} / {x}_{jk 0} ) .$$

For instance, we might choose a cross-entropy function:

$${x}_{ij 0} = \frac{{s}_{j} {d}_{k}}{{\sum }_{j \text{:} {\overline{S}}_{j} ⊆ {S}_{k}}^{ } {S}_{j}} 1 ( j ∈ \{ j \text{:} \overline{Sj} ⊆ {S}_{k} \} )$$

This only changes the solution in (8) slightly with ln(xᵢⱼₖ) being replaced by ln(xⱼₖ)−ln(xⱼₖ₀). Also, the weighting value γ in (5) can be replaced by γlₖ, where the multiplier lₖ is a campaign specific parameter reflecting the importance we give in ensuring representative allocation to the campaign k. The relative weight lₖ may be derived from domain knowledge and business constraints.

Use of the cross entropy function allows us to relate our approach to the method described above with reference to (5). Writing Δxⱼₖ=xⱼₖ−xⱼₖ₀ and f(xⱼₖ)=Σ_{j,k} xⱼₖln(xⱼₖ/xⱼₖ₀), the Taylor expansion of f(x) about xⱼₖ₀ is:

F(xⱼₖ)=f(xⱼₖ₀)+Δf′(xⱼₖ₀)+(Δx²ⱼₖ/2)f″(xⱼₖ₀)+ . . .

we note that f(xⱼₖ₀)=0, f′(xⱼₖ₀)=1 and f″(xⱼₖ₀)=1/xⱼₖ₀. Hence

$$\begin{matrix}{\sum }_{j , k}^{ } {x}_{jk} ln ( {x}_{jk} / {x}_{jk 0} ) = {\sum }_{j , k}^{ } ( {x}_{jk} - {x}_{jk 0} ) + \\ {\sum }_{j , k}^{ } [ {( {x}_{jk} - {x}_{jk 0} )}^{2} / 2 {x}_{jk 0} ] + … \\ \approx {\sum }_{j , k}^{ } [ {( {x}_{jk} - {x}_{jk 0} )}^{2} / 2 {x}_{jk 0} ]\end{matrix}$$

Referring back to the objective function in (5) ΣⱼVⱼyⱼ−γΣ_{j,k}ln(xⱼₖ), we may replace the entropy function

$${\sum }_{j , k}^{ } {x}_{jk} ln ( {x}_{jk} )$$

with

$${\sum }_{j , k}^{ } {x}_{jk} ln ( {x}_{jk} / {x}_{jk 0} ) ,$$

which may be replaced with its equivalent

$${\sum }_{j , k}^{ } [ {( {x}_{jk} - {x}_{jk 0} )}^{2} / 2 {x}_{jk 0} ] ,$$

as set forth above. Thus, in this case, we may maximize the value of

$${\sum }_{j}^{ } {V}_{j} {y}_{j} - γ {\sum }_{j , k}^{ } [ {( {x}_{jk} - {x}_{jk 0} )}^{2} / 2 {x}_{jk 0} ] .$$

(xⱼₖ−xⱼₖ₀)²/2xⱼₖ₀].

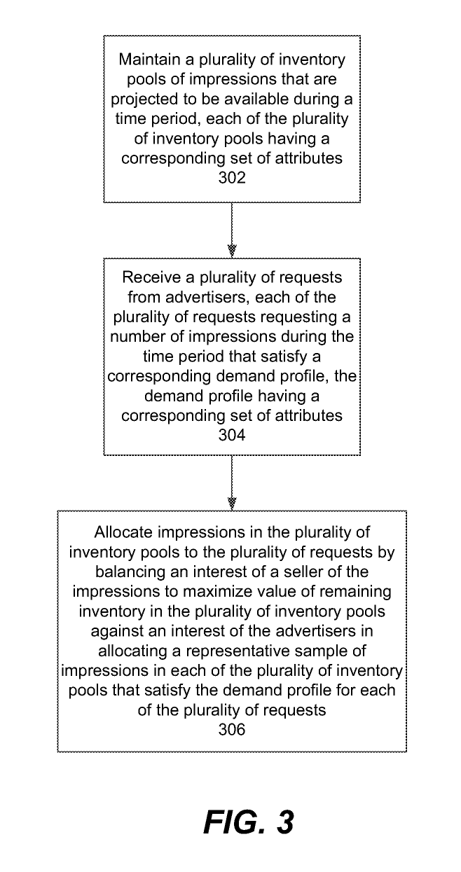

FIG. 3 is a process flow diagram illustrating an example method of allocating overlapping inventory as described above. The system may maintain a plurality of inventory pools of impressions that are projected to be available during a time period at 302, each of the plurality of inventory pools having a corresponding set of attributes. For example, the set of attributes for each of the plurality of inventory pools may include at least one of an age, gender, or geographical location of an individual or corresponding advertising opportunity. Moreover, the set of attributes for each of the plurality of inventory pools may indicate behavioral attributes including prior Internet activity of an individual (e.g., impression).

The system may receive a plurality of requests from advertisers at 304, each of the plurality of requests requesting a number of impressions during the time period that satisfy a corresponding demand profile, the demand profile having a corresponding set of attributes. The set of attributes for each demand profile may include at least one of a desired age, gender, or geographical location of the requested number of impressions. Moreover, the set of attributes for each demand profile may indicate desired behavioral attributes of the requested number of impressions. Each of the requests may also indicate a desired position for ad placement within a web page.

The system may allocate impressions in the plurality of inventory pools to the plurality of requests at 306. The system may allocate impressions by balancing an interest of a seller of the impressions to maximize value of remaining inventory in the plurality of inventory pools against an interest of the advertisers in allocating a representative sample of impressions in each of the plurality of inventory pools that satisfy the demand profile for each of the plurality of requests. For instance, the system may calculate a number of impressions in one or more of the plurality of inventory pools to allocate to each of the plurality of requests by applying a weighting value that reflects a weighting of an interest of a seller of the impressions to maximize value of remaining inventory in the plurality of inventory pools against an interest of the advertisers in allocating a representative sample of impressions in each of the plurality of inventory pools that satisfy the demand profile for each of the plurality of requests.

Allocation of impressions may be accomplished by calculating a number of impressions in one or more of the plurality of inventory pools to allocate to each one of the plurality of requests using the expected value of the inventory in each of the plurality of inventory pools that is projected to be available during the time period, the number of impressions projected to be available in each of the plurality of inventory pools during the time period, and a total requested number of impressions for each demand profile. The number of impressions that are projected to be available in each of the plurality of inventory pools during the time period may be ascertained using historical data. The expected value of the inventory in each of the plurality of inventory pools that is projected to be available during the time period may be assigned, as set forth above.

The system may then compute a price to be charged each of the advertisers based upon the allocation of the impressions to the plurality of requests. For instance, each impression may have a charge associated therewith based upon the value assigned to the associated pool of impressions from which the impression was allocated. In this manner, a total price for all of the impressions allocated to a particular request may be determined.

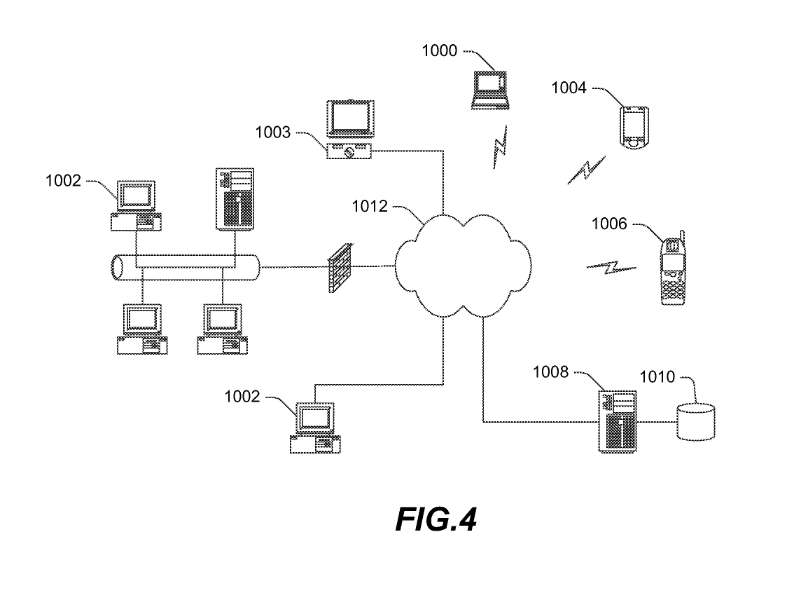

Embodiments of the present invention may be employed to support the operation of an advertising service in any of a wide variety of contexts. For example, as illustrated in FIG. 4, implementations are contemplated in which a user 1000 interacts with a diverse network environment which may include any type of computer (e.g., desktop, laptop, tablet, etc.) 1002, media computing platforms 1003 (e.g., cable and satellite set top boxes and digital video recorders), handheld computing devices (e.g., PDAs) 1004, cell phones 1006, server 1008 or any other type of device.

And according to various embodiments, information associated with the user (e.g., attributes) may be obtained using a wide variety of techniques. For example, the information may be obtained via a local application and/or web site and may be accomplished using any of a variety of processes such as those described herein. However, it should be understood that such methods of obtaining this information are merely examples and that the information may be obtained in many other ways.

A web site is represented in FIG. 4 by the server 1008 and data store 1010 which, as will be understood, may correspond to multiple distributed devices and data stores. The invention may also be practiced in a wide variety of network environments (represented by network 1012) including, for example, TCP/IP-based networks, telecommunications networks, wireless networks, etc. In addition, the computer program instructions with which embodiments of the invention are implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations. Thus, computer-program instructions for performing various disclosed processes may be stored at the user's computer 1000, as well as the server 1008.

The disclosed techniques of the disclosed embodiments may be implemented in any suitable combination of software and/or hardware system, such as a web-based server used in conjunction with a web-browser. The system of this invention may be specially constructed for the required purposes, or may be a general-purpose computer selectively activated or reconfigured by a computer program and/or data structure stored in the computer. The processes presented herein are not inherently related to any particular computer or other apparatus. In particular, various general-purpose machines may be used with programs written in accordance with the teachings herein, or it may be more convenient to construct a more specialized apparatus to perform the required method steps.

Regardless of the system's configuration, the user's computer 1000, the server 1008, and/or other devices in the network may each employ one or more memories or memory modules configured to store data, program instructions for the general-purpose processing operations and/or the inventive techniques described herein. The program instructions may control the operation of an operating system and/or one or more applications, for example. The memory or memories may also be configured to store data structures such as pools of impressions, software for allocating impressions, various requests received from advertisers, and previously determined allocations of impressions, etc.

Because such information and program instructions may be employed to implement the systems/methods described herein, the disclosed embodiments relate to machine readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.

Although the foregoing invention has been described in some detail for purposes of clarity of understanding, it will be apparent that certain changes and modifications may be practiced within the scope of the appended claims. Therefore, the present embodiments are to be considered as illustrative and not restrictive and the invention is not to be limited to the details given herein, but may be modified within the scope and equivalents of the appended claims.

What is claimed is:

1. A method, comprising:
maintaining a plurality of inventory pools of impressions that are projected to be available during a time period, each of the plurality of inventory pools having a corresponding set of attributes;
receiving a plurality of requests from advertisers, each of the plurality of requests requesting a number of impressions during the time period that satisfy a corresponding demand profile, the demand profile having a corresponding set of attributes; and
allocating impressions in the plurality of inventory pools to the plurality of requests by balancing an interest of a seller of the impressions to maximize value of remaining inventory in the plurality of inventory pools against an interest of the advertisers in allocating a representative sample of impressions in each of the plurality of inventory pools that satisfy the demand profile for each of the plurality of requests.

2. The method as recited in claim 1, wherein each of the plurality of requests indicates a position for ad placement.

3. The method as recited in claim 1, further comprising;
ascertaining a number of impressions that are projected to be available in each of the plurality of inventory pools during the time period using historical data.

4. The method as recited in claim 1, further comprising:
balancing the interest of the seller against the interest of the advertisers using a weighting value.

5. The method as recited in claim 1, wherein the set of attributes for each of the plurality of inventory pools includes at least one of an age, gender, or geographical location of an individual.

6. The method as recited in claim 1, wherein the set of attributes for each of the plurality of inventory pools indicates behavioral attributes including prior Internet activity of an individual.

7. The method as recited in claim 1, wherein the set of attributes for each demand profile includes at least one of a desired age, gender, or geographical location of the requested number of impressions.

8. The method as recited in claim 1, wherein the set of attributes for each demand profile indicates desired behavioral attributes of the requested number of impressions.

9. The method as recited in claim 1, further comprising:
computing a price to be charged each of the advertisers based upon the allocation of the impressions to the plurality of requests.

11. The method as recited in claim 1, wherein receiving a plurality of requests from advertisers comprises:
determining a maximum number of impressions satisfying a demand profile in response to an inquiry from one of the advertisers.

12. The method as recited in claim 1, wherein allocating impressions comprises:
calculating a number of impressions in one or more of the plurality of inventory pools to allocate to each one of the plurality of requests using the expected value of the inventory in each of the plurality of inventory pools that is projected to be available during the time period, the number of impressions projected to be available in each of the plurality of inventory pools during the time period, and a total requested number of impressions for each of demand profile.

13. A method, comprising:
maintaining a plurality of inventory pools of impressions that are projected to be available during a time period, each of the plurality of inventory pools having a corresponding set of attributes;
receiving a plurality of requests from advertisers, each of the plurality of requests requesting a number of impressions during the time period that satisfy a corresponding demand profile, the demand profile having a corresponding set of attributes; and
allocating impressions in the plurality of inventory pools to the plurality of requests using an expected value of the inventory in each of the plurality of inventory pools that is projected to be available during the time period, a number of impressions projected to be available in each of the plurality of inventory pools during the time period, and a total requested number of impressions for each demand profile.

14. The method as recited in claim 13, wherein allocating impressions comprises:
calculating a number of impressions in one or more of the plurality of inventory pools to allocate to each one of the plurality of requests.

15. The method as recited in claim 14, wherein calculating a number of impressions is performed by applying a weighting value that reflects a weighting of an interest of a seller of the impressions to maximize value of remaining inventory in the plurality of inventory pools against an interest of the advertisers in allocating a representative sample of impressions in each of the plurality of inventory pools that satisfy the demand profile for each of the plurality of requests.

16. An apparatus, comprising:
a processor; and
a memory, at least one of the processor or the memory being adapted for:
maintaining a plurality of inventory pools of impressions that are projected to be available during a time period, each of the plurality of inventory pools having a corresponding set of attributes;
receiving a plurality of requests from advertisers, each of the plurality of requests requesting a number of impressions during the time period that satisfy a corresponding demand profile, the demand profile having a corresponding set of attributes; and
allocating impressions in the plurality of inventory pools to the plurality of requests by balancing an interest of a seller of the impressions to maximize value of remaining inventory in the plurality of inventory pools against an interest of the advertisers in allocating a representative sample of impressions in each of the plurality of inventory pools that satisfy the demand profile for each of the plurality of requests.

17. The apparatus as recited in claim 16, at least one of the processor or the memory being further adapted for:
ascertaining a number of impressions that are projected to be available in each of the plurality of inventory pools during the time period using historical data.

18. The apparatus as recited in claim 16, at least one of the processor or the memory being further adapted for:
balancing the interest of the seller against the interest of the advertisers using a weighting value.

19. The apparatus as recited in claim 16, wherein the set of attributes for each of the plurality of inventory pools includes at least one of an age, gender, or geographical location of an individual.

20. The apparatus as recited in claim 16, wherein the set of attributes for each of the plurality of inventory pools indicates behavioral attributes including prior Internet activity of an individual.
